(19) United States
(12) Patent Application Publication
(10) Pub. No.: US 2025/0022303 A1
(43) Pub. Date: Jan. 16, 2025

(54) IMAGE PROCESSING SYSTEM AND NON-TRANSITORY COMPUTER-READABLE STORAGE MEDIUM

(71) Applicant: FUJIFILM Business Innovation Corp., Tokyo (JP)

(72) Inventor: Joji SAITO, Kanagawa (JP)

(73) Assignee: FUJIFILM Business Innovation Corp., Tokyo (JP)

(21) Appl. No.: 18/592,674

(22) Filed: Mar. 1, 2024

(30) Foreign Application Priority Data
Jul. 10, 2023 (JP) 2023-112877

(51) Int. Cl. G06V 30/418; G06T 5/50

(52) U.S. Cl. CPC G06V 30/418; G06T 5/50; G06T 2207/20224

(57) ABSTRACT

An image processing system includes an image capturing unit and a processor, wherein, when the image capturing unit captures an image above a document platen and generates a captured image as a current captured image, and when a change is detected from the current captured image with respect to a captured image that is a lastly captured image resultant of last image capturing, the processor identifies an occupied area occupied by all documents resting on the document platen as an entire occupied area, by analyzing the current captured image, and confirms an area resultant of subtracting an occupied area occupied by a document an occupied area of which has already been confirmed, from the entire occupied area, as an occupied area of one document placed on the document platen during a period from when the lastly captured image has been generated to when the current captured image has been generated.

### CROSS-REFERENCE TO RELATED APPLICATIONS

This application is based on and claims priority under 35 USC 119 from Japanese Patent Application No. 2023-112877 filed Jul. 10, 2023.

### BACKGROUND

### (i) Technical Field

The present invention relates to an image processing system and a non-transitory computer-readable storage medium.

### (ii) Related Art

In recent years, it has become possible to replace a document reader, which is generally referred to as a scanner, with the use of, for example, an image captured with a camera of a mobile terminal. For example, by transmitting an image captured by a camera of a mobile terminal to a printer, the captured image can be printed.

For a multifunction peripheral, too, it has come to be considered to mount an image capturing unit, such as a document camera, on the multifunction peripheral, and to use a captured image captured by the image capturing unit as a read image. In a configuration in which the document camera is mounted on a multifunction peripheral, a user places a document with the printed face up, on a document platen. The document camera then reads the document on the document platen by capturing an image of the document from above. When the document camera is used, unlike with a conventional multifunction peripheral, it is not necessary to open and to close the cover of the platen to place a document on the document platen. Such use of a document camera is also useful in reading pages of a three dimensional object such as a book.

Conventionally, there have also been some multifunction peripherals capable of providing a multi-cropping function. The multi-cropping function is a function, after a plurality of documents, such as business cards and receipts, are placed on the document platen of a multifunction peripheral, of reading the documents all at once, then splitting and cropping the scanned image into the respective documents, and storing the individual pieces of data.

Conventionally having been disclosed is a technique in which, after a plurality of documents are placed on a document platen without any space therebetween, the documents are scanned all at once, and the scanned images are split in units of a unit size having been set in advance, and the split images are stored as separate files (e.g., JP2008-035081A). While it has been necessary, in order to detect the individual documents placed on the document platen, to place the documents with some space therebetween, the technique disclosed in JP2008-035081A makes it possible to place documents without any space therebetween by causing a user designate the unit size in advance.

### SUMMARY

However, such a related art requires a user to designate the unit size, that is, the size of the documents, in advance.

Aspects of non-limiting exemplary embodiments of the present disclosure relate to an image processing system capable of, after generating a captured image by capturing an image of a plurality of documents placed side by side on a document platen, identifying the size of each of the documents from the captured image, even without causing a user to designate the size.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing system comprising an image capturing unit and a processor,

wherein, when the image capturing unit captures an image above a document platen and generates a captured image as a current captured image, and when a change is detected from the current captured image with respect to a captured image that is a lastly captured image resultant of last image capturing, the processor identifies an occupied area occupied by all documents resting on the document platen as an entire occupied area, by analyzing the current captured image, and confirms an area resultant of subtracting an occupied area occupied by a document an occupied area of which has already been confirmed, from the entire occupied area, as an occupied area of one document placed on the document platen during a period from when the lastly captured image has been generated to when the current captured image has been generated.

### BRIEF DESCRIPTION OF THE DRAWINGS

Exemplary embodiments of the present invention will be described in detail based on the following figures, wherein:

FIG. 1 is a block diagram of a multifunction peripheral included in an image processing system according to a first exemplary embodiment;

FIG. 2 is a schematic perspective view of the multifunction peripheral according to the first exemplary embodiment;

FIG. 3 is a diagram of a hardware configuration of the multifunction peripheral according to the first exemplary embodiment;

FIG. 4 is a flowchart illustrating a document image storing process according to the first exemplary embodiment;

FIGS. 5A to 5F are diagrams each illustrating a transition in the arrangement of documents on a document platen, and the transition in the detected document areas during the pre-scan according to the first exemplary embodiment;

FIGS. 6A to 6C are diagrams each illustrating a transition in the arrangement of documents on the document platen, and the transition in the detected document areas during the main scan according to the first exemplary embodiment;

FIG. 7 is a block diagram of a multifunction peripheral included in an image processing system according to a second exemplary embodiment;

FIG. 8 is a flowchart illustrating a document image storing process according to the second exemplary embodiment;

FIGS. 9A to 9F are diagrams each illustrating a transition in the arrangement of the documents on the document platen, and the transition in the detected document areas during the pre-scan according to the second exemplary embodiment;

FIGS. 10A to 10E are diagrams each illustrating a transition in the arrangement of the documents on another document platen, and the transition in the detected document areas during the pre-scan according to the second exemplary embodiment; and

FIG. 11 is a flowchart illustrating a modification of the document image storing process according to the second exemplary embodiment.

### DETAILED DESCRIPTION

Preferred exemplary embodiments of the present invention will be described with reference to drawings.

### First Exemplary Embodiment

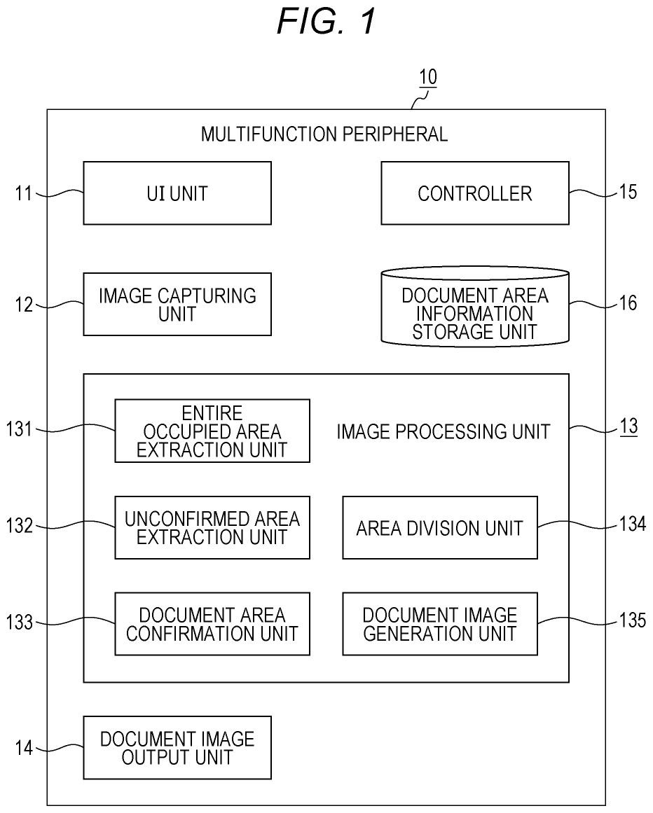

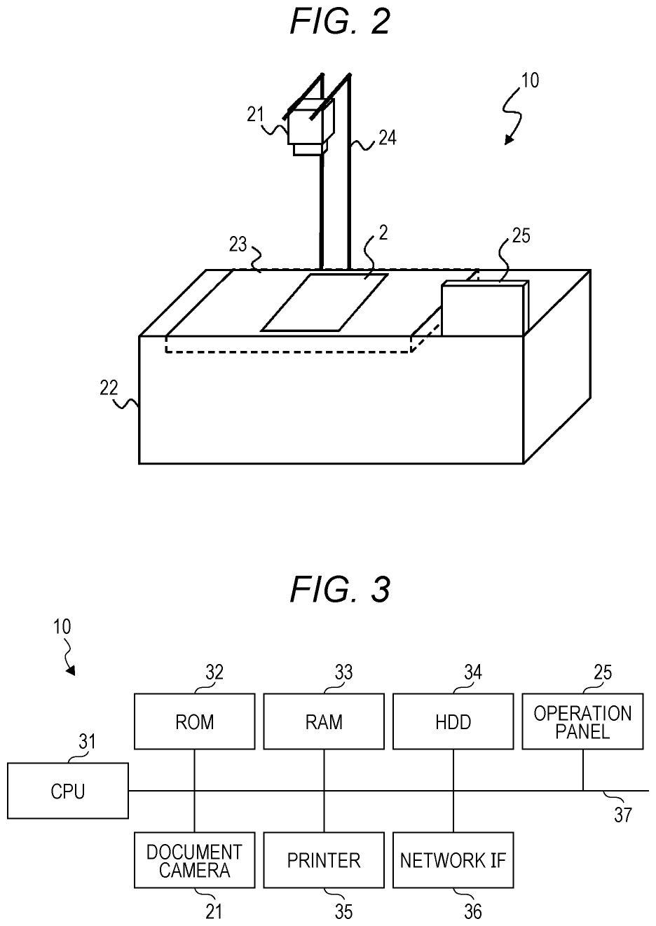

FIG. 1 is a block diagram of a multi-function peripheral 10 included in an image processing system according to an exemplary embodiment of the present invention. FIG. 2 is a schematic perspective view of the multifunction peripheral 10 according to the present exemplary embodiment, and FIG. 3 is a diagram of a hardware configuration of the multifunction peripheral 10 according to the present exemplary embodiment.

The multifunction peripheral 10 according to the present exemplary embodiment is characterized in that a document camera 21 is mounted as a component thereof, as illustrated in FIG. 2. The multifunction peripheral 10 includes a document platen 23 provided on the top surface of an apparatus main body 22, and the document camera 21 capable of capturing an image of the entire document platen 23. The document camera 21 is supported on a support rod 24. On the top surface of the apparatus main body 22, an operation panel 25 functioning as an input unit operated by a user, and also as a display unit for displaying information is provided.

The multifunction peripheral 10 according to the present exemplary embodiment is one implementation of an image forming apparatus including various functions such as a printing function, a copying function, and a scanning function, and is an apparatus including an internal computer. That is, the multifunction peripheral 10 includes a CPU 31, a ROM 32, and a RAM 33, a hard disk drive (HDD) 34 as a storage unit, the operation panel 25 as a user interface, the document camera 21 as an image capturing unit, a printer 35 providing a printing function, and a network interface (IF) 36 as a communication unit, as illustrated in FIG. 3. An address data bus 37 connects various mechanisms 31 to 36, 21, and 25 that are to be controlled by the CPU 31, and performs data communication.

In order to implement a scanning function, a conventional multifunction peripheral generally has included a scanner that optically reads a document 2 on the document platen 23. The multifunction peripheral 10 according to the present exemplary embodiment, however, includes the document camera 21, instead of a scanner. Therefore, a read image of the document 2 is generated from a captured image resultant of causing the document camera 21 to capture an image, or by analyzing a captured image. The document camera 21 generates a captured image of the document 2 by capturing an image of the document 2 on the document platen 23. However, it can also be said that the document camera 21 reads the document 2 by capturing an image, and therefore, in the present exemplary embodiment, expressions “capturing an image” and “reading” are used synonymously, without strictly distinguishing one from the other. Hence, by interpreting “capturing an image” by the document camera 21 as “reading”, “capturing an image” by the document camera 21 are sometimes referred to as “reading” or “scanning”.

As illustrated in FIG. 1, the multifunction peripheral 10 according to the present exemplary embodiment includes a user interface (UI) unit 11, an image capturing unit 12, an image processing unit 13, a document image output unit 14, a controller 15, and a document area information storage unit 16. Note that components not used in the description of the exemplary embodiment are omitted in the drawings.

The user interface unit 11 is implemented by the operation panel 25, and displays screens for various menus of the multi-function peripheral 10. The user interface unit 11 also receives a user operation on the displayed screen. The image capturing unit 12 is implemented by the document camera 21, and captures an image of the entire top surface of the document platen 23, as an imaging area. Note that, in the present exemplary embodiment, for the convenience of description, it is assumed that the imaging area of the image capturing unit 12 equals to the area of the top surface of the document platen 23. Even if these areas do not match, it is possible to extract an image only corresponding to the top surface of the document platen 23 from the captured image, by means of image processing performed by the image processing unit 13.

The image processing unit 13 performs image processing to the image captured by the document camera 21. The image processing unit 13 includes an entire occupied area extraction unit 131, an unconfirmed area extraction unit 132, a document area confirmation unit 133, an area division unit 134, and a document image generation unit 135.

The entire occupied area extraction unit 131 extracts an area occupied by a document 2, from the captured image acquired from the image capturing unit 12. Needlessly to say, the document 2 has a size referred under names such as a sheet size. When the document 2 is placed on the document platen 23, the entire surface of the document 2 is brought into contact with the top surface of the document platen 23, and therefore, takes up an occupied area, corresponding to the sheet size, in the area of the top surface of the document platen 23. Of course, the document 2 may be placed in a manner overlapping with another document 2, or in a manner sticking out from the document platen 23. However, in the present exemplary embodiment, when the document 2 is placed on the document platen 23 and is brought into contact with the top surface of the document platen 23, the resultant range (or area) occupied by the document 2 resting on the document platen 23 will be referred to as an “occupied area” or simply as a “document area”. When the entire document is in contact with the top surface of the document platen 23, the sheet size of the document 2 equals to the size of the document area.

When the document 2 has been placed in plurality, the entire occupied area extraction unit 131 extracts the occupied area corresponding to the entire plurality of documents 2, that is, the all documents 2 resting on the document platen 23. Therefore, in the present exemplary embodiment, the occupied areas corresponding to the documents 2 resting on the top surface of the document platen 23 and to be extracted by the entire occupied area extraction unit 131 will be referred to as an “entire occupied area”. When only one document 2 has been placed, the entire occupied area corresponds to the range occupied by the one resting document 2.

The unconfirmed area extraction unit 132 extracts an unconfirmed document area by subtracting a confirmed document area from the entire occupied area extracted by the entire occupied area extraction unit 131. The “confirmed document area” refers to a document area of the document 2 for which the range of positions occupied thereby on the document platen 23 (i.e., the document area) has been confirmed by a pre-scan, which is performed prior to a main scan, to be described later in detail. Speaking more precisely, even after the document area of the document 2 has been confirmed in the last pre-scan, there are some exceptional cases in which the confirmed document area is to be corrected. Such a correction will be described later.

The document area confirmation unit 133 confirms an unconfirmed document area extracted by subtracting the confirmed document area from the entire occupied area, as the document area of a document 2 having been newly detected. With this confirmation of the document area confirmation unit 133, the unconfirmed document area is established as a confirmed document area. Once the document area is confirmed, area information for allowing the document area to be identified is retained and managed in the document area information storage unit 16. For the area information for allowing the document area to be identified, it is possible to map the top surface of the document platen 23 to XY coordinates, and to represent the area information as coordinate values in two dimensional coordinates, for example, using one corner of the document platen 23 as the origin of the XY coordinates.

The area division unit 134 splits the entire occupied area extracted by the unconfirmed area extraction unit 132 into segments, using the confirmed document area, when the main scan is performed. The document image generation unit 135 generates a read image of the documents 2 (hereinafter, also referred to as a “document images”) by cropping the captured image of the document 2 from the captured image of the entire occupied area, based on the areas resultant of split by the area division unit 134.

The document image output unit 14 outputs the read images of the respective documents 2, the images being generated by the document image generation unit 135, to a predetermined target. The target may be, for example, a predetermined storage unit, the operation panel 25, or a display unit on another computer. The controller 15 controls the operations of the elements 11 to 14 described above.

The document area information storage unit 16 stores therein the area information corresponding to the document areas of the respective documents 2, having been confirmed by the document area confirmation unit 133 during the pre-scan.

Each of the elements 11 to 15 of the multi-function peripheral 10 is implemented by a computer mounted on the multi-function peripheral 10, cooperating with a program operating on the CPU 31 mounted on the computer. The document area information storage unit 16 is implemented by the HDD 34 mounted on the multifunction peripheral 10. Alternatively, it is possible to use the RAM 33, or an external storage unit over a network.

The program used in the present exemplary embodiment may be provided not only by the communication unit but also in a manner stored in a computer-readable storage medium such as a USB memory. The program provided from the communication unit or the storage media is installed in the computer, and various kinds of processing are implemented by causing the CPU 31 on the computer to sequentially execute the program.

The multifunction peripheral 10 included in the image processing system is illustrated as a single apparatus, but may be implemented as a combination of a plurality of computers, information processing apparatuses, or image forming apparatuses.

An operation according to the present exemplary embodiment will now be described.

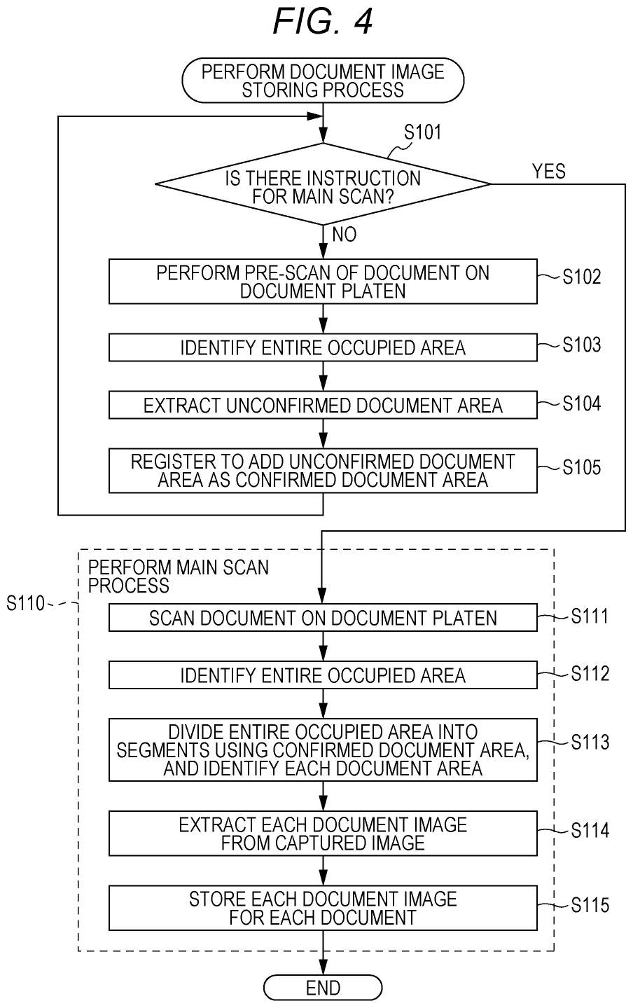

The present exemplary embodiment is characterized in that, even when a plurality of documents 2 are placed on the document platen 23 and scanned at once, the read images of all of the documents 2 can be generated and stored separately, without causing the user to designate the paper size of each of the plurality of documents 2 or the same paper size for all of the documents 2, nor imposing any set conditions or restrictions, such as ensuring a gap between the placed documents 2. Next, a process for storing document images according to the present exemplary embodiment will be described with reference to the flowchart illustrated in FIG. 4. Note that, at the point in time at which the document image storing process illustrated in FIG. 4 is started, no area information is stored in the document area information storage unit 16. The document area information storage unit 16 may be initialized at an appropriate timing, e.g., at the start of the document image storing process or the end of the main scan. Let us now describe an example in which two documents A and B are scanned at once as the plurality of documents 2.

When the user uses the scanning function of the multifunction peripheral 10, the user logs into the multifunction peripheral 10 or operates a home screen or the like displayed on the operation panel 25. The document camera 21 starts capturing images at regular time intervals, in response to a user operation. Note that this image capturing by the document camera 21 started in response to login or the like is referred to as “pre-scan”, because it is started before the user gives an instruction to scan. By contrast, a scan performed to acquire a read image of the document 2 in response to a scan instruction issued by a user is referred to as a “main scan”.

The user places a document 2 on the document platen 23 before or after pre-scan is started. At this time, the user places documents 2 one by one, with a printed surface to be read by the document camera 21 facing up.

If the user does not give any instruction of the main scan (N in step S101), the image capturing unit 12 performs a pre-scan using the document camera 21 (step S102). Because the user gives an instruction for the main scan after the user finishes placing the documents 2 to be scanned at once on the document platen 23, the image capturing unit 12 performs the pre-scan repeatedly using the document camera 21 until the user finishes placing all of the documents 2, as illustrated in FIG. 4.

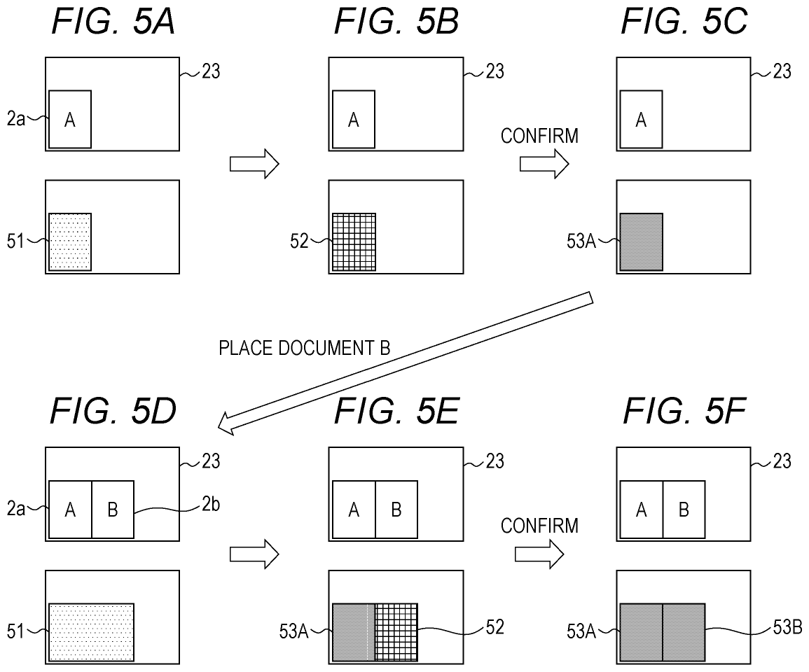

FIGS. 5A to 5F are diagrams each used in describing the process at the time of a pre-scan. Each of FIGS. 5A to 5F includes drawings in a pair of an upper section and a lower section. The upper section represents an image captured in a pre-scan, and represents the document 2 resting on the document platen 23 during the pre-scan. The lower section illustrates the document area acquired from the captured image illustrated in the upper section. To be more specific, FIGS. 5A to 5C illustrate a process for acquiring a confirmed document area 53A from a captured image captured by a single pre-scan. In the same manner, FIGS. 5D to 5F illustrate a process of acquiring a confirmed document area 53B from a captured image captured by a single pre-scan.

If the user places documents 2 on the document platen 23 at a time interval longer than or equal to a time interval of a pre-scan performed by the document camera 21, there would be basically no change between the captured image at a certain point in time with respect to the captured image acquired immediately subsequently to the certain point in time. Therefore, even when the pre-scan is performed repeatedly at regular intervals, as long as no change is detected between the image captured by a last pre-scan (hereinafter referred to as “lastly captured image”) and the image captured by a current pre-scan (hereinafter referred to as “current captured image”), it is not necessary to perform any special process, in the document image storing process according to the present exemplary embodiment. Therefore, the process at the time of the pre-scan illustrated in FIG. 4 (steps S102 to S105) is performed when a change is detected between the current captured image and the lastly captured image.

To begin with, upon acquiring the captured image from the image capturing unit 12, the entire occupied area extraction unit 131 in the image processing unit 13 analyzes the captured image (the “current captured image” at the current point in time), and identifies, from the current captured image, an entire occupied area that is the sum of the document areas of all of the documents 2 resting on the document platen 23 (step S103). The entire occupied area can be easily extracted from the captured image by, for example, taking a difference between a captured image of the top surface of the document platen 23 without any document 2, and a captured image resultant of the current pre-scan.

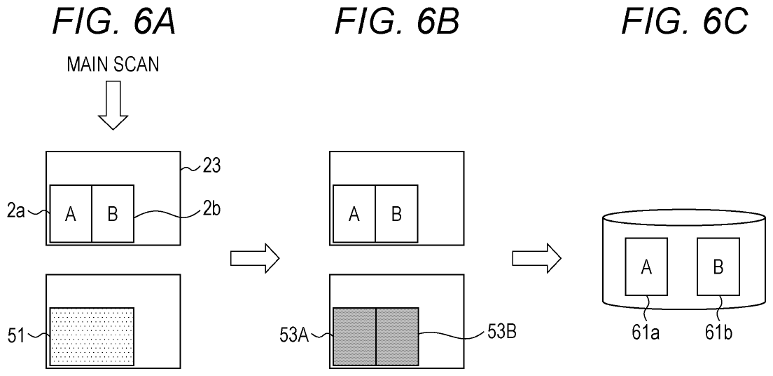

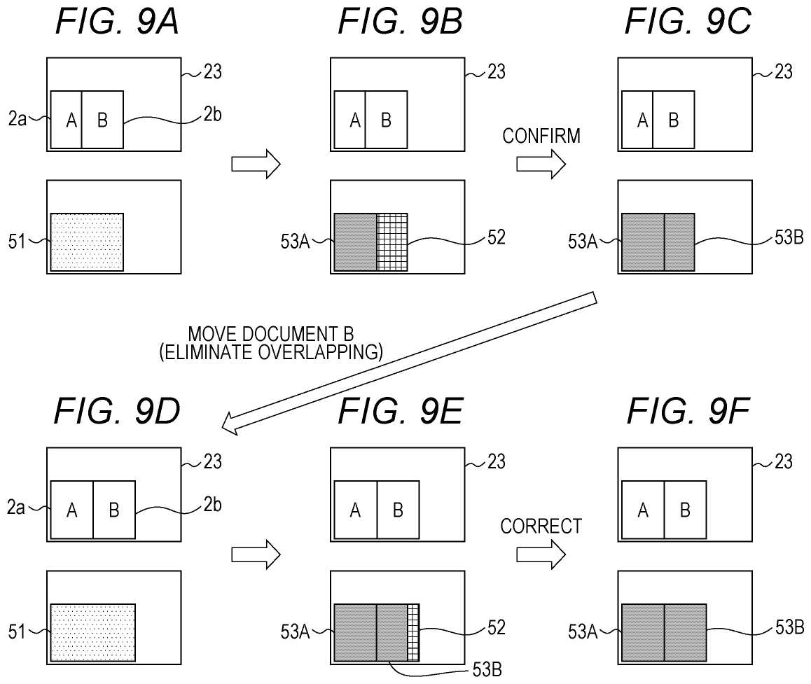

The upper section of FIG. 5A illustrates the document platen 23 having only one document 2a (“document A” in FIG. 5A). The corresponding lower section of FIG. 5A illustrates the entire occupied area 51 with this document setting. At this time, because the document platen 23 has only one document 2a, the entire occupied area 51 is equal to the area of the document 2a. In FIGS. 5A and 5D, the entire occupied area 51 is indicated by a dot pattern. The same applies to FIG. 6A, and FIGS. 9A and 9D described below.

The unconfirmed area extraction unit 132 then extracts an unconfirmed document area 52, by taking out the area information corresponding to a confirmed document area that is the document area of the document 2 having the document area been already confirmed, from the document area information storage unit 16, and subtracting the confirmed document area from the entire occupied area 51 by referring to the area information (step S104).

In FIG. 5A, the document 2a is the first document 2 placed on the document platen 23. Assuming that the captured image illustrated in the upper section of FIG. 5A is a current captured image, the lastly captured image at the current point in time is a captured image with no document 2 placed on the document platen 23. Therefore, the lastly captured image has had no confirmed document area to be additionally registered. The unconfirmed area extraction unit 132 therefore has no confirmed document area for which the area information is to be taken out from the document area information storage unit 16. The entire occupied area 51 therefore corresponds to the unconfirmed document area 52, as illustrated in FIG. 5B. In FIG. 5B, the unconfirmed document area 52 is indicated by a grid-like pattern. The same applies to FIG. 9B, to described below.

The document area confirmation unit 133 then confirms the unconfirmed document area 52 extracted by the unconfirmed area extraction unit 132, as the document area of the one document 2 resting on the document platen 23, the one document 2 having been placed during the period from when the captured image without the document 2 (that, is the lastly captured image at the current point in time) has been generated to when the captured image illustrated in the upper section in FIG. 5A (i.e., the current captured image at the current point in time) has been generated. In other words, the document area confirmation unit 133 confirms the unconfirmed document area 52 as the document area of the document 2a. To put in other words, the unconfirmed document area 52 extracted by the unconfirmed area extraction unit 132 is established as the confirmed document area 53A corresponding to the document 2a. Note that, in FIGS. 5C, 5E, and 5F, the confirmed document area 53 is indicated by being filled with gray scale. The same applies to FIGS. 6B, 9B, 9C, 9E, and 9F, and 10B, 10C, and 10E to be described below.

The image processing unit 13 registers to add the area information for identifying the confirmed document area 53A of the document 2a, to the document area information storage unit 16 (step S105). The process then goes to step S101.

Because the user intends to scan two documents 2 at once, the user then places a second document 2b on the document platen 23. At the current point in time, no instruction for a main scan has been given. In this case (N in step S101), the image capturing unit 12 performs a pre-scan, using the document camera 21 (step S102). The captured image resultant of this pre-scan is illustrated in the upper section of FIG. 5D. Upon completion of this pre-scan, the captured image illustrated in the upper section of FIG. 5D corresponds to the current captured image, and the captured image illustrated in the upper section of FIG. 5A corresponds to the lastly captured image.

Upon acquiring the image captured by the document camera 21, the entire occupied area extraction unit 131 extracts the entire occupied area 51 that is the sum of the document areas of all of the documents 2 resting on the document platen 23 from the captured image, in the manner described above (step S103). At the current point in time, the sum of document areas of the document 2a and the document 2b (“document B” in FIG. 5D) correspond to the entire occupied area 51, as illustrated in the lower section of FIG. 5D. Because the document 2a and the document 2b are placed with no space therebetween, the entire occupied area 51 is recognized as one document area having the size of the two documents 2.

The unconfirmed area extraction unit 132 extracts the unconfirmed document area 52, by subtracting the confirmed document area of the document 2 from the entire occupied area 51, in the same manner as described above (step S104). At this time, because there is the confirmed document area 53A corresponding to the document 2a, as illustrated in the lower section of FIG. 5E, the unconfirmed area extraction unit 132 confirms that the document area of the document 2b, which has just been newly placed on the document platen 23, corresponds to the unconfirmed document area 52.

The document area confirmation unit 133 then confirms the unconfirmed document area 52 extracted by the unconfirmed area extraction unit 132 as the document area of the document 2 resting on the document platen 23, the document 2 having been placed during the period from when the captured image illustrated in FIG. 5A (that is, the lastly captured image at the current point in time) has been generated to when the captured image illustrated in the upper section of FIG. 5D (that is, the current captured image at the current point in time) has been generated. In other words, the document area confirmation unit 133 confirms the unconfirmed document area 5 as the document area of the document 2b. To put in other words, the unconfirmed document area 52 extracted by the unconfirmed area extraction unit 132 is established as a confirmed document area 53B corresponding to the document 2b. The image processing unit 13 registers to add the area information for identifying the confirmed document area 53B corresponding to the document 2b, to the document area information storage unit 16 (step S105). As a result, at the current point in time, the area information of the confirmed document area 53A corresponding to the document 2a and the area information of the confirmed document area 53B corresponding to the document 2b are registered in the document area information storage unit 16. The process then goes to step S101.

Because the user has completed placing the two documents 2a, 2b that the user intends to scan at once, the user provides an instruction for a main scan, by making a predetermined operation on the operation panel 25. In this case (Y in step S101), the image capturing unit 12 performs the main scan using the document camera 21 (step S111). Note that the scan process itself performed by the document camera 21 are same for the pre-scan and the main scan.

Upon acquiring the image captured by the document camera 21, the entire occupied area extraction unit 131 identifies the entire occupied area that is the sum of the document areas of all of the documents 2 resting on the document platen 23 in the captured image, in the same manner as in the pre-scan (step S112).

FIGS. 6A to 6C are diagrams each used in describing the processing at the time of a main scan. In the same manner as FIGS. 5A to 5F, each of FIGS. 6A and 6B also includes a pair of upper section and a lower section. The upper section and the lower section in FIG. 6A are both the same as those in FIG. 5D, respectively. As illustrated in the lower section in FIG. 6A, the entire occupied area 51 has the size of the document area that is the sum of the document areas of both the document 2a and the document 2b.

The area division unit 134 takes out the area information of the confirmed document areas from the document area information storage unit 16, and splits the entire occupied area 51 into segments, using the confirmed document areas corresponding to the area information. As a result, the document areas of the documents 2a, 2b are identified (step S113). In the lower section of FIG. 6B, the document areas having been split and confirmed correspondingly to the respective documents 2a, 2b are illustrated. Both of the upper and lower sections of FIG. 6B are the same as those in FIG. 5F, respectively.

As described above, once the document areas of all the documents 2a, 2b placed on the document platen 23 are confirmed, the document image generation unit 135 extracts the read images of the documents 2a, 2b, by cropping the captured images of the documents 2a, 2b from the image captured by the document camera 21 or from the captured image of the entire occupied area 51 (step S114).

The document image outputting unit 14 then stores the read images 61a, 61b of the documents 2a, 2b, the read images 61a, 61b having been extracted and generated by the document image generation unit 135, in a predetermined target, e.g., a storage unit designated as the target, as illustrated in FIG. 6C (step S115).

As described above, in the present exemplary embodiment, even when the plurality of documents 2a, 2b are read by a single scan, the read images of the respective documents 2 can be stored correspondingly to the respective documents 2. In particular, as illustrated in FIG. 6A, even when the plurality of documents 2a, 2b are resting side by side without any space therebetween, and thus the entire occupied area 51 is detected as a single area, the read images of the plurality of respective documents 2 resting on the document platen 23 can be stored for separately for the respective documents 2. For example, even if the documents 2a, 2b each having the A4 size are arranged without any space therebetween, in the present exemplary embodiment, the documents can be determined correctly as two documents 2 having the A4size, not as one document having the A3 size.

### Second Exemplary Embodiment

As described above, the user places the plurality of documents 2 on the document platen 23 sequentially one by one, and then gives an instruction for performing a scan at once (the “main scan”). However, it is not always possible for a user to place the documents 2 on the document platen 23 at positions as intended, without any displacement. For example, the user may place a next document 2 in a manner overlapping with the document 2 having been already placed. In such a case, it is quite probable that the user will move the document 2 placed on the document platen 23 so as to eliminate the overlap. It is also quite probable for the user to displace the document 2 having already been placed, that is, the document 2a or the document 2b for which the document area has been confirmed in the manner described in the first exemplary embodiment. According to the present exemplary embodiment, such situations can also be addressed.

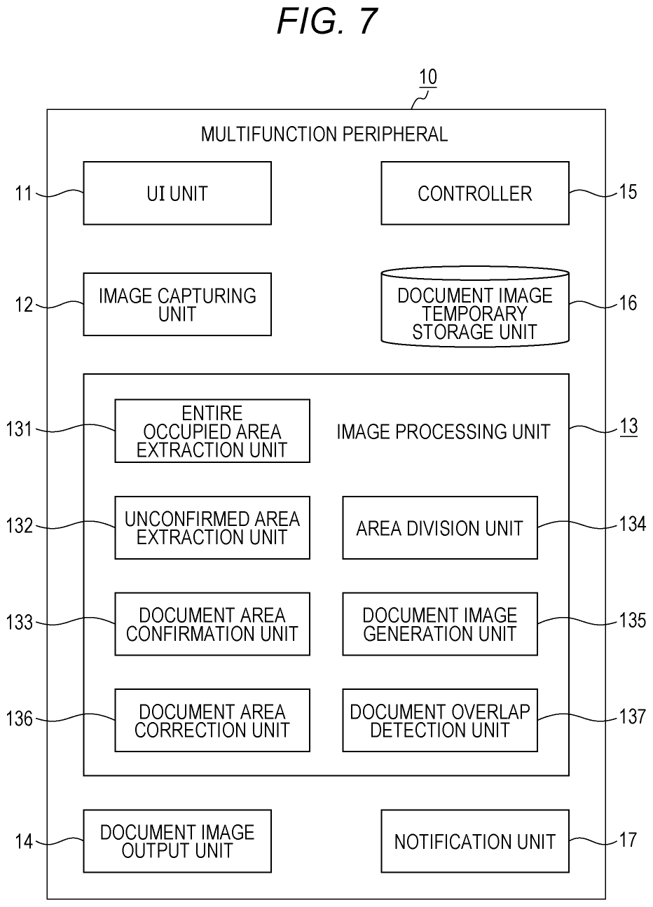

FIG. 7 is a block diagram of a multifunction peripheral 10 included in an image processing system according to the present exemplary embodiment. The multifunction peripheral 10 according to the present exemplary embodiment has a configuration with a notification unit 17 added to the multifunction peripheral 10 according to the first exemplary embodiment. A document area correction unit 136 and a document overlap detection unit 137 are also newly added to the image processing unit 13.

When overlap of documents 2 is detected, the notification unit 17 notifies the user of the overlap. The notification unit 17 is implemented by causing a computer mounted on the multi-function peripheral 10 to cooperate with a program operating on the CPU 31 mounted on the computer. When it is determined that a confirmed document area needs to be corrected because the documents 2 having been placed overlap each other, the document area correction unit 136 corrects the confirmed document area. The document overlap detection unit 137 detects overlap of the documents 2 having the document areas already been confirmed.

The multifunction peripheral 10 according to the present exemplary embodiment may have the same hardware configuration as that according to the first exemplary embodiment illustrated in FIGS. 2 and 3.

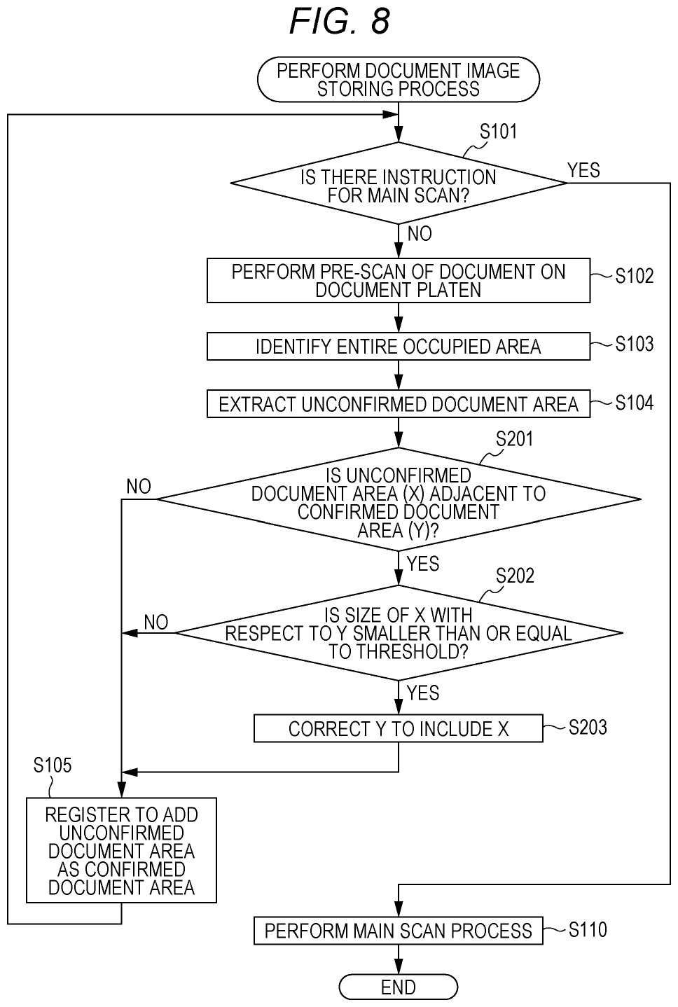

Next, a process for storing document images according to the present exemplary embodiment will be described with reference to the flowchart illustrated in FIG. 8. The same processing steps as those in the document image storing process according to the first exemplary embodiment illustrated in FIG. 4 are denoted by the same reference numerals, and the descriptions thereof are omitted as appropriate. In this exemplary embodiment, an example in which two documents 2a, 2b are scanned at once will be described, in the same manner as in the first exemplary embodiment.

FIGS. 9A to 9F are diagrams each used for describing processing at the time of the pre-scan, and corresponds to FIGS. 5A to 5F used in the first exemplary embodiment. In the present exemplary embodiment, because the same process can be performed on the first document 2a, as the process according to first exemplary embodiment described with reference to FIGS. 5A to 5C, the description of the processing of the first document 2a is omitted in FIGS. 9A to 9F. To describe with reference to the flowchart illustrated in FIG. 8, at the point in time at which the first document 2a is placed on the document platen 23, there is no confirmed document area (N in step S101, S102 to S104), as illustrated in FIG. 5A. The unconfirmed document area 52 (denoted as “X” in FIG. 8 for convenience) corresponding to the document 2a illustrated in FIG. 5B is not positioned adjacently to any confirmed document area (denoted as “Y” in FIG. 8 for convenience), in other words, there is no such a confirmed document area to be positioned adjacently (NO in step S201). Therefore, the image processing unit 13 registers to add the area information for identifying the confirmed document area 53A of the document 2a, to the document area information storage unit 16 (step S105), in the same manner in the first exemplary embodiment. The process then goes to step S101.

Next, it is assumed herein that, although the user has tried to place the document 2b next to the document 2a without any space therebetween, as illustrated in FIG. 5D) (or FIG. 9D), the user ends up placing the documents slightly overlapping with each other, as illustrated in the upper section of FIG. 9A. When the document 2b is placed overlapping with the document 2a, the document camera 21 cannot capture the image of an overlapping portion of the document 2a, overlapping with the document 2b. The present exemplary embodiment is an exemplary embodiment configured to eliminate such a defect in the overlapping documents 2.

Referring to the entire occupied area 51 identified from the current captured image illustrated in the upper section of FIG. 9A as a “current entire occupied area”, and referring the entire occupied area 51 identified from the lastly captured image illustrated in the upper section of FIG. 5A as a “last entire occupied area”, in the present exemplary embodiment, it is determined that the document 2b is overlapping with the document 2a if a relationship between the current entire occupied area and the last entire occupied area satisfies a predetermined condition for determining that a document (document 2b at the current point in time) is overlapping with another document (i.e., document 2a) on the document platen 23. In the present exemplary embodiment, an example of the predetermined condition will be described in steps S201 to S202.

To being with, as illustrated in FIG. 9B, the unconfirmed area extraction unit 132 extracts the document area of the document 2b, as an unconfirmed document area 52 (step S104). The unconfirmed document area 52 in the present exemplary embodiment is the area corresponding to the difference between the last entire occupied area and the current entire occupied area. Because the document 2b is overlapping with the document 2a, the unconfirmed document area 52 is smaller than the actual sheet size of the document 2b.

The unconfirmed document area 52 corresponding to the document 2b is positioned adjacently to the confirmed document area 53A of the document 2a, without any space therebetween. In this case (Y in step S201), the image processing unit 13 calculates the ratio of the unconfirmed document area 52 (i.e., the difference area) with respect to the size of the last entire occupied area (i.e., the confirmed document area 53A). If the size of the unconfirmed document area 52 with respect to the size of the last entire occupied area is not smaller than or equal to a predetermined threshold (N in step S202), the document area confirmation unit 133 confirms such an unconfirmed document area 52 as the document area of the newly placed document 2b. Note that the threshold will be described later in detail. The image processing unit 13 then registers to add the area information for identifying the confirmed document area 53B of the document 2b, to the document area information storage unit 16 (step S105). The process then goes to step S101. Note that from the above description, it can be easily assumed that the confirmed document area 53B needs to be corrected.

The user, having noticed that the document 2b has been placed in a manner overlapping with the document 2a, moves the document 2b slightly on the document platen 23, to eliminate the overlap of the documents 2a, 2b, as illustrated in the upper section of FIG. 9D. FIG. 9D, illustrating the documents after the user has eliminated the overlap, is the same as FIG. 5D. As is clear from this user operation, the user has not placed a new document 2 on the document platen 23.

By performing the pre-scan after the document 2b has been moved, the entire occupied area 51 illustrated in the lower section of FIG. 9A is established as the last entire occupied area, and the entire occupied area 51 illustrated in the lower section of FIG. 9D is established as the current entire occupied area.

The unconfirmed area extraction unit 132 then extracts area information of the confirmed document areas 53A, 53B of the respective documents 2a, 2b from the document area information storage unit 16, and subtracts the document areas 53A, 53B corresponding to the area information from the entire occupied area 51 illustrated in the lower section of FIG. 9D, thereby extracting the unconfirmed document area 52, illustrated in the lower section of FIG. 9E (step S104). This unconfirmed document area 52, that is, the difference area between the last entire occupied area and the current entire occupied area actually corresponds to a part of the document 2b that has appeared because the user has made an operation for eliminating the overlap. However, only with the basic process described in the first exemplary embodiment, this area is processed as a new document having been just placed. In other words, the confirmed document area 53B and the unconfirmed document area 52 illustrated in FIG. 9E are processed as separate documents 2.

Therefore, in the present exemplary embodiment, a determination is made based on the predetermined condition. In other words, the unconfirmed document area 52 illustrated in FIG. 9E is positioned adjacently to the confirmed document area 53B, without any space therebetween. In this case (Y in step S201), the image processing unit 13 calculates the ratio of the unconfirmed document area 52 (i.e., the difference area) with respect to the size of the last entire occupied area (i.e., the confirmed document areas 53A, 53B). If the size of the unconfirmed document area 52 is not smaller than or equal to the predetermined threshold, with respect to the size of the last entire occupied area (N in step S202), the image processing unit 13 determines the unconfirmed document area 52 as a confirmed document area, and registers to add the area information for identifying the confirmed document area, to the document area information storage unit 16 (step S105).

By contrast, if the ratio of the unconfirmed document area 52 with respect to the size of the last entire occupied area is smaller than or equal to the predetermined threshold (Y in step S202), the document area correction unit 136 corrects the document area 53B corresponding to the document 2b so as to include the difference area between the last entire occupied area and the current entire occupied area, that is, the unconfirmed document area 52 acquired from the current captured image, illustrated in the lower section of FIG. 9E, in the document area 53B of the document 2b, the document area 53B having been confirmed in the processing in the last pre-scan (step S203). The image processing unit 13 thus takes out the document area 53B of the document 2b registered in the document area information storage unit 16, adds the unconfirmed document area 52 to the document area 53B, establishes the result as an unconfirmed document area acquired from the current captured image, and registers to add the area information identifying the unconfirmed document area, to the document area information storage unit 16 (step S105). The process then goes to step S101.

As described above, in the present exemplary embodiment, a positional relationship of, in particular, adjacency of the difference area (the unconfirmed document area 52) between the last entire occupied area and the current entire occupied area with the last entire occupied area is used as an example of the predetermined condition for determining that one document (the document 2b in the example described above) is overlapping with another document (the document 2a in the example described above) placed on the document platen 23. If the difference area is not positioned adjacently to the last entire occupied area, it is clear that the document 2 corresponding to the difference area is a document 2 separate from one or more documents 2 corresponding to the last entire occupied area. In other words, the unconfirmed document area 52 is not resultant of a user operation for eliminating overlap.

Furthermore, the reason why the ratio of the difference area with respect to the size of the current entire occupied area is compared with the predetermined threshold is that, if the unconfirmed document area 52 is resultant of a user operation for eliminating overlapping, it can be expected for the size of the unconfirmed document area 52 to be relatively small. In the present exemplary embodiment, for example, 50% is assumed as a threshold to be used, serving as a criterion for determining the presence of overlap, but the threshold is not limited thereto. For example, the threshold may be set as appropriate depending on factors such as the size of the document platen 23 and the size and the number of documents 2 to be scanned at once. Alternatively, a user may be allowed to set the threshold.

Another possible situation is that, when a user places documents 2 on the document platen 23, the user holds the two documents 2 at once by mistake, and to place the two documents 2 on top of each other in a manner slightly misaligned with respect to each other. In such a case, the size of the unconfirmed document area 52 resultant of moving one document 2 may exceed the threshold of about 50% with respect to the last entire occupied area. In the configuration described in the present exemplary embodiment, the threshold is set to automatically detect a user operation for eliminating overlap, and to automatically correct the confirmed document area 53. However, it is also possible to use a configuration in which the user is notified that the documents 2 may be overlapping, so as to prompt the user to determine whether the documents 2 are overlapping. Furthermore, it is also possible to display a message prompting the user to place the documents 2 again.

According to the present exemplary embodiment, as described above, it is possible to correct the document area 53B of the document 2b even when the user has placed a new document 2b in a manner slightly overlapping with the document 2a having been placed previously. Therefore, the read images of the respective documents 2a, 2b can be stored correctly, and the documents 2 can be stored separately.

In the first exemplary embodiment, as a process for identifying the position of the document 2 on the document platen 23, a basic process for identifying an occupied area of the top surface of the document platen 23, occupied by the document 2, has been described. Contrary to this basic process, the process described in the present exemplary embodiment is configured to address a situation in which the user places a new document 2b in a manner overlapping with another document 2a the position of which has already been confirmed, and the document 2b is moved to eliminate the overlapping. In addition to these examples, it is also possible for the document 2 having the document area already confirmed to become displaced on the document platen 23, due to a user operation or the like. The present exemplary embodiment is configured to be able to address such a case as well.

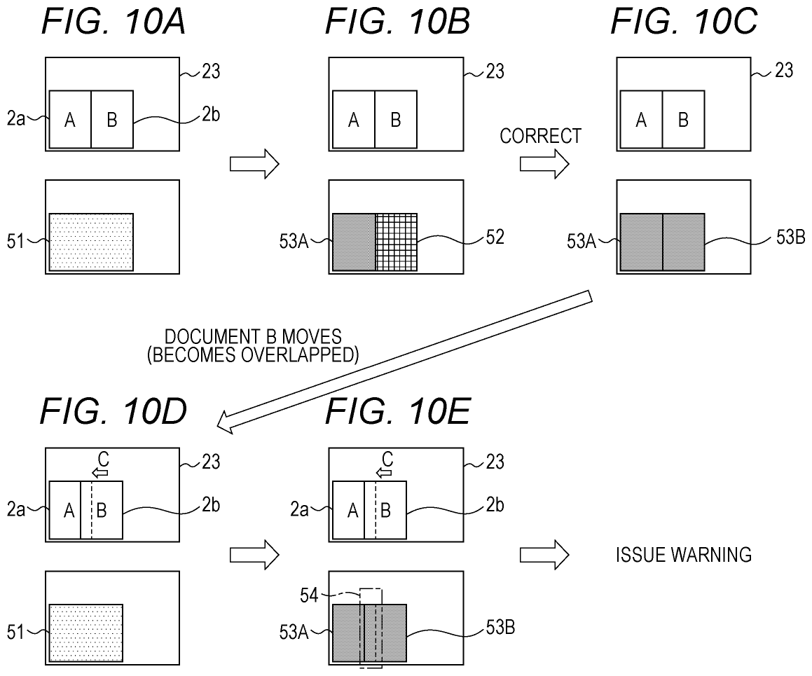

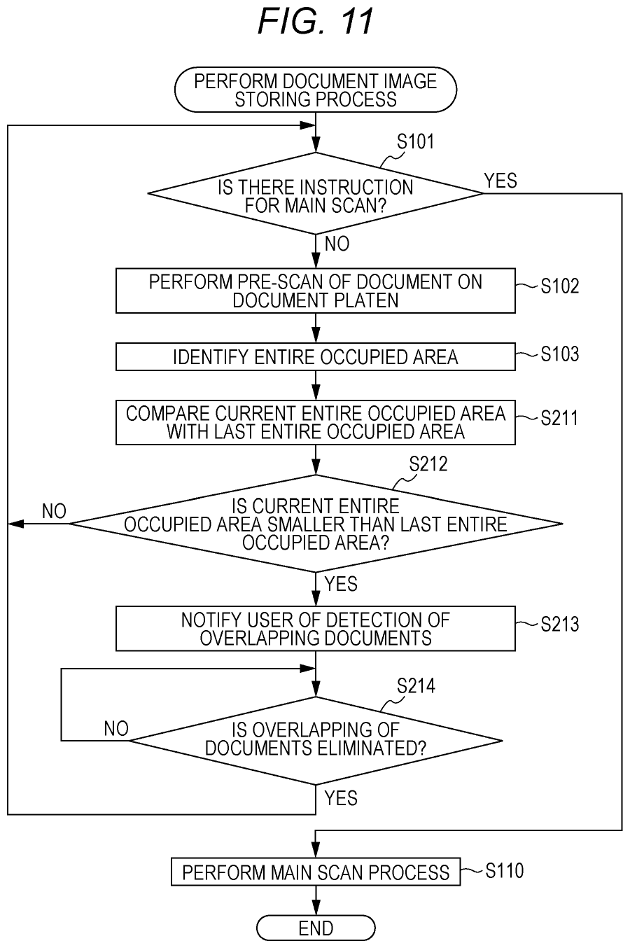

FIGS. 10A to 10E are diagrams each used for describing processing at the time of pre-scan, and corresponds to FIGS. 5A to 5F used in the first exemplary embodiment. Among the drawings included, FIGS. 10A to 10C correspond to FIGS. 5D to 5F, respectively, indicating that the document areas 53A, 53B of the two documents 2a, 2b have already been confirmed. The upper section of FIG. 10D illustrates a situation in which the document 2b has been moved in the direction of the arrow C, that is, in the direction toward the document 2a, and become overlapping with the document 2a. A document image storing processing capable of addressing such a situation, in which the document 2 moves after the document area of the document 2 has been confirmed will be described with reference to the flowchart illustrated in FIG. 11. Note that the same processing steps as those included in the document image storing process according to the first exemplary embodiment illustrated in FIG. 4 are denoted by the same reference numerals, and the descriptions thereof are omitted as appropriate.

FIGS. 10A to 10C are the same as FIGS. 5D to 5F, so the descriptions thereof will be omitted. As illustrated in the upper section of FIG. 10D, if a pre-scan is performed on the document 2b having becomes displaced and overlapping with the document 2a after the document area of the document 2b is confirmed (NO in step S101 and step S102), the entire occupied area extraction unit 131 extracts the entire occupied area 51, as illustrated in the lower section of FIG. 10D (step S103).

The document overlap detection unit 137 compares the last entire occupied area 51 illustrated in the lower section of FIG. 10A, with the current entire occupied area 51 illustrated in the lower section of FIG. 10D. Because the physical sizes of the documents 2 do not change, if the current entire occupied area 51 is smaller than the size of the last entire occupied area 51, it can be assumed that there is an overlapping area 54, as surrounded by a one dot chain line in the lower section of FIG. 10E, where the document area 53A and the document area 53B overlap with each other. Because there is such an overlapping area 54, the size of the current entire occupied area 51 is smaller than the size of the last entire occupied area 51. Therefore, the document overlap detection unit 137 can detect that one of the documents 2 (the document 2b in FIG. 10D) has moved and become overlapping with another document 2 (the document 2a in FIG. 10D). Note that it is also possible to detect that the current entire occupied area 51 includes some overlapping area 54 from the fact that, although a change has been detected in the captured image of the document platen 23, the unconfirmed area extraction unit 132 fails to extract the unconfirmed document area by subtracting the confirmed document areas 53A, 53B of the respective documents 2a, 2b from the current entire occupied area 51, in step S104. When the size of the current entire occupied area 51 is equal to the size of any one of the documents 2, e. g., the document 2a, it can be confirmed that the document 2b has been removed from the document platen 23. When the size of the current entire occupied area 51 is larger than the size of the last entire occupied area 51, there is a possibility that the document 2b has been moved to eliminate overlap, as has been described with reference to FIGS. 8 and 9.

As described above, if the current entire occupied area 51 is smaller than the last entire occupied area 51 (Y in step S212), the document overlap detection unit 137 recognizes that the document areas 53 having been already confirmed overlap with each other. In this manner, when the document overlap detection unit 137 detects overlap of the documents 2, the notification unit 17 issues a warning to the user by displaying a message on the operation panel 25, for example (step S213). The multifunction peripheral 10 keeps the warning until the overlap of the documents 2 is eliminated (NO in step S214). If the user receiving the warning adjusts the position of the document 2b, and the overlap of the documents 2 is eliminated (Y in step S214), the process goes to step S101.

The determination as to whether overlap of documents 2 has been eliminated may be made by making the user to make an input to indicate that the documents 2 have been moved and the overlap is eliminated, on the operation panel 25. It is also possible to execute the processing of a pre-scan to check whether the overlap of the documents 2 has been eliminated (steps S102 to 212).

As described above, according to the present exemplary embodiment, it is possible to issue a warning to the user by detecting overlap of the document 2b with another document 2a as a result of a displacement of the document 2b the document area of which has been previously confirmed.

As long as the document 2b is not overlapping with another document 2a, even if the document 2b has become displaced, the document 2b can be scanned correctly and the read image of the document 2b can be acquired appropriately. Therefore, it can be considered that it is not always necessary to issue a warning. Therefore, in the present exemplary embodiment, when it is detected that the occupied area of the document 2b, the occupied area of which has already been confirmed, has moved, by comparing the last entire occupied area identified from the lastly captured image and the current entire occupied area identified from the current captured image, the image processing unit 13 performs a process suitable for the condition of the document 2b having moved.

Considering cases in which the document 2b has moved, as described above, there are a case in which the document 2b has moved and become overlapping with the document 2a, so that a change making the current entire occupied area smaller than the last entire occupied area is detected, and a case in which no change in size is detected simply because the document 2b has moved but does not overlap with the document 2a, so that only change is that the current entire occupied area and the last entire occupied area do not match. In the former case, as described above, the notification unit 17 notifies the user of the overlap of the documents 2, under the control of the controller 15. In the latter case, the document 2b has merely moved on the document platen 23. Therefore, in this case, under the control of the controller, the image processing unit 13 may update the area information of the confirmed document area of the document 2b registered in the document area information storage unit 16, to the area information of the document area of the document 2b having moved. In this case, it is possible for the notification unit 17 to or not to notify the user that the document 2b has moved.

As described above, in the present exemplary embodiment, for the convenience of description, the process performed when overlap of the documents 2 is eliminated (FIG. 8) and the process performed when overlap of the documents 2 is detected (FIG. 11) are illustrated in separate flowcharts, but these processes may be integrated. Specifically, when the current entire occupied area 51 is not smaller than the last entire occupied area 51 (N in step S212), the process may be shifted to step S104 illustrated in FIG. 8, instead of 101.

Note that in the present exemplary embodiment, the document camera 21 is mounted on the multifunction peripheral 10, as a unit for reading the document 2, instead of a conventional scanner. However, when a conventional scanner is mounted on the multifunction peripheral 10, it is also possible to use the document camera 21 and the scanner in combination, as a unit for reading the document 2. As described above, the document camera 21 according to the present exemplary embodiment performs two types of scans, i.e., the “pre-scan” and the “main scan”. However, when the multifunction peripheral 10 includes a conventional scanner, the “main scan” may be performed by the scanner.

In the exemplary embodiments described above, the processor refers to a processor in a broad sense, and includes a general-purpose processor (e.g., a central processing unit (CPU)) and a dedicated processor (such as a graphics processing unit (GPU), an application-specific integrated circuit (ASIC), a field-programmable gate array (FPGA), or a programmable logic device).

Furthermore, the operation of the processor in the exemplary embodiments described above may be performed not only by one processor but also by causing a plurality of processors that are at positions physically separated from each other to operate in cooperation with one another. Furthermore, the order of the operations performed by the processor is not limited to the order described in the exemplary embodiments, and may be changed as appropriate.

### Notes

(((1)))

An image processing system comprising an image capturing unit and a processor,

wherein, when the image capturing unit captures an image above a document platen and generates a captured image as a current captured image, and when a change is detected from the current captured image with respect to a captured image that is a lastly captured image resultant of last image capturing, the processor identifies an occupied area occupied by all documents resting on the document platen as an entire occupied area, by analyzing the current captured image, and confirms an area resultant of subtracting an occupied area occupied by a document an occupied area of which has already been confirmed, from the entire occupied area, as an occupied area of one document placed on the document platen during a period from when the lastly captured image has been generated to when the current captured image has been generated.

(((2)))

The image processing system described in (((1))), wherein,

establishing the entire occupied area identified from the current captured image as a current entire occupied area, and establishing the entire occupied area identified from the lastly captured image as a last entire occupied area, the processor is configured to, when a relationship between the last entire occupied area and the current entire occupied area satisfies a predetermined condition for determining that one document has been placed overlapping with another document resting on the document platen, correct an occupied area of the one document, the occupied area of which has already been confirmed, to include a difference area between the last entire occupied area and the current entire occupied area.

(((3)))

The image processing system described in (((2))), wherein

the predetermined condition is that the difference area is positioned adjacently to the last entire occupied area, and a ratio of the difference area with respect to a size of the last entire occupied area is smaller than or equal to a predetermined threshold.

(((4)))

The image processing system described in (((1))) or (((2))), wherein,

establishing the entire occupied area identified from the current captured image as a current entire occupied area, and establishing the entire occupied area identified from the lastly captured image as a last entire occupied area, the processor is configured to, when a detection is made that an occupied area of a document, the occupied area of which has been confirmed, has moved, by comparing the last entire occupied area with the current entire occupied area, perform a process depending on a condition of the document having moved.

(((5))

The image processing system described in (((4))), wherein

the processor is configured to, when the occupied area of the document having moved has changed in size, notify a user of overlap of the documents.

(((6)))

The image processing system described in (((4))), wherein

the processor is configured to, when the occupied area of the document having moved has not changed in size, to update the occupied area of the document to the occupied area after the document have moved.

(((7)))

A non-transitory computer-readable storage medium storing a program for causing a computer to implement:

a function of, when the image capturing unit captures an image above a document platen and generates a captured image as a current captured image, and when a change is detected from the current captured image with respect to a captured image that is a lastly captured image resultant of last image capturing,

identifying an occupied area occupied by all documents resting on the document platen as an entire occupied area, by analyzing the current captured image, and

confirming an area resultant of subtracting an occupied area occupied by a document an occupied area of which has already been confirmed, from the entire occupied area, as an occupied area of one document placed on the document platen during a period from when the lastly captured image has been generated to when the current captured image has been generated.

What is claimed is:

1. An image processing system comprising an image capturing unit and a processor,
wherein, when the image capturing unit captures an image above a document platen and generates a captured image as a current captured image, and when a change is detected from the current captured image with respect to a captured image that is a lastly captured image resultant of last image capturing, the processor identifies an occupied area occupied by all documents resting on the document platen as an entire occupied area, by analyzing the current captured image, and confirms an area resultant of subtracting an occupied area occupied by a document an occupied area of which has already been confirmed, from the entire occupied area, as an occupied area of one document placed on the document platen during a period from when the lastly captured image has been generated to when the current captured image has been generated.

2. The image processing system according to claim 1, wherein,
establishing the entire occupied area identified from the current captured image as a current entire occupied area, and establishing the entire occupied area identified from the lastly captured image as a last entire occupied area, the processor is configured to, when a relationship between the last entire occupied area and the current entire occupied area satisfies a predetermined condition for determining that one document has been placed overlapping with another document resting on the document platen, correct an occupied area of the one document, the occupied area of which has already been confirmed, to include a difference area between the last entire occupied area and the current entire occupied area.

3. The image processing system according to claim 2, wherein
the predetermined condition is that the difference area is positioned adjacently to the last entire occupied area, and a ratio of the difference area with respect to a size of the last entire occupied area is smaller than or equal to a predetermined threshold.

4. The image processing system according to claim 1, wherein,
establishing the entire occupied area identified from the current captured image as a current entire occupied area, and establishing the entire occupied area identified from the lastly captured image as a last entire occupied area, the processor is configured to, when a detection is made that an occupied area of a document, the occupied area of which has been confirmed, has moved, by comparing the last entire occupied area with the current entire occupied area, perform a process depending on a condition of the document having moved.

5. The image processing system according to claim 4, wherein
the processor is configured to, when the occupied area of the document having moved has changed in size, notify a user of overlap of the documents.

6. The image processing system according to claim 4, wherein
the processor is configured to, when the occupied area of the document having moved has not changed in size, to update the occupied area of the document to the occupied area after the document have moved.

7. A non-transitory computer-readable storage medium storing a program for causing a computer to implement:
a function of, when an image capturing unit captures an image above a document platen and generates a captured image as a current captured image, and when a change is detected from the current captured image with respect to a captured image that is a lastly captured image resultant of last image capturing,
identifying an occupied area occupied by all documents resting on the document platen as an entire occupied area, by analyzing the current captured image, and
confirming an area resultant of subtracting an occupied area occupied by a document an occupied area of which has already been confirmed, from the entire occupied area, as an occupied area of one document placed on the document platen during a period from when the lastly captured image has been generated to when the current captured image has been generated.
